(19) United States
(12) Patent Application Publication
(10) Pub. No.: US 2005/0265510 A1
(43) Pub. Date: Dec. 1, 2005

(54) Multi-plant adaptable boiling water reactor inspection work platform

(76) Inventors: Rush Jennings, Blueridge, VA (US); Skip Lowman JR., Madison, VA (US); Austin Sizemore, Forest, VA (US); Andrew C. Smith, Huddleston, VA (US); Greg L. Martin, Lynchburg, VA (US)

Correspondence Address: VYTAS R. MATAS, 2412 CEDARWOOD RD., PEPPER PIKE, OH, 44124, US

(21) Appl. No.: 11/126,656

(22) Filed: May 11, 2005

Related U.S. Application Data
(60) Provisional application No. 60/571,468, filed on May 14, 2004.

(51) Int. Cl. G21C 19/00

(52) U.S. Cl. 376/260

(57) ABSTRACT

The present invention provides a multiple section work platform capable of being installed in various BWRs with each section being easily transported in sea-land containers and easily assembled on site to fit the refueling cavity of various BWRs having differing refuel floor configurations by the refuel floor supporting the work platform through a series of outrigger assemblies which are movable both longitudinally and radially with respect to the work platform to clear critical refuel floor areas such as service pits.

### BACKGROUND OF THE INVENTION

1. Field of the Invention

The present application is generally drawn to Boiling Water Reactor (BWR) work platforms and more particularly to portable multi function work platforms adjustably installable over the reactor cavity of different reactors during refueling of the reactors.

2. Description of the Prior Art

Much of the maintenance performed in nuclear power plants is similar to that for conventional non-nuclear systems. This includes equipment lubrication, fluid level checks, adjustments, and in-service inspections. Because most of the active systems are fluid (water, steam or air) systems, most of the work is performed on pumps, valves, fans and filters. In addition, the electrical distribution systems and the instrument and control (IC) systems require regularly scheduled maintenance. As previously discussed, nuclear systems are unique in that many components are inaccessible.

The reactor vessel and its internals are static components requiring little maintenance. Activities that are performed during each refueling outage focus on the integrity of the reactor vessel. During refueling, the reactor vessel head must be removed from the reactor vessel to gain access to the core. When this is done some of the irradiated fuel assemblies are removed and replaced with new fuel assemblies, while the other fuel assemblies are reshuffled within the reactor core. This is also the time when the various vessel components are inspected for wear and defects. The process of fuel movement and vessel inspection was done in series in previous outages.

A work platform is assembled and installed prior to this fuel movement process and is used for the mentioned inspection functions. Various such inspection platforms or decks are known and some are described in the following US patents.

U.S. Pat. No. 5,102,612 provides a permanent deck structure or platform that is outside of the reactor cavity and allows remote access to the reactor annulus for inspection and repair if necessary.

U.S. Pat. No. 5,359,632 provides an annular plate around the outside of the reactor with inner and outer support rings with access ports therein. Thus inspection is done remotely to the cavity.

U.S. Pat. No. 5,295,167 provides an auxiliary refueling bridge work platform mounted on a rigid frame adjacent to the work station. The platform is attached to a movable platform crane which is positioned to allow the use of the platform. As such this platform can not be used during refueling.

In view of the above known platforms it will be seen that a portable and easily assembled work platform which could be adjustably installed inside the reactor cavity of various reactors and could be used simultaneously with the refueling operation to allow inspection and repair of the reactor vessel from the upper cavity region was sorely needed.

### SUMMARY OF THE INVENTION

The present invention solves the mentioned problems of the prior work platforms and others by providing a multi section work platform capable of being mounted in various BWRs utilizing sections that are easily transported in sea-land containers and installed into the reactor cavity of various BWRs having differing refueling floor configurations. The platform is supported by the refuel floor and provides sufficient head room for personnel to provide simultaneous inspection and repair of the reactor during the movement of the individual fuel assemblies during the refueling process.

The work platform is easily assembled from the plurality of sections into an annular ring having a plurality of baskets allowing workers to be on the platform to provide inspection and repair functions. The assembled platform also has an opening therein for fuel movement during the inspection work process. The platform is supported by a plurality of adjustable legs or outriggers which adjust both laterally and radially to clear various critical refuel floor obstructions such as service pits which allows for adaptation to various refuel floor configurations.

In view of the above it will be seen that one aspect of the present invention is to provide a reactor refueling work platform which is situated inside the reactor cavity to allow simultaneous inspection/repair of the reactor during fuel movement activities.

Another aspect of the present invention is to provide a portable work platform which is formed from a plurality of sections and is easily assembled and installed into the reactor cavity to allow local inspection/repair of the reactor.

Yet another aspect is to provide a portable work platform having a plurality of assembled sections which is easily disassembled and each section shipped to another reactor location in its own designated sea-land container.

Still yet another aspect is to provide a portable work platform having a plurality of adjustable legs for supporting the platform on various reactor refueling floor configurations.

Still yet another aspect is to provide a portable work platform having a plurality of adjustable legs which extend longitudinally as well as rotating radially to avoid refueling floor obstructions which allows for adaptation to various refuel floor configurations.

These and other aspects of the present invention will be more fully understood after a perusal of the following description of the preferred embodiment, when considered along with the accompanying drawings.

### BRIEF DESCRIPTION OF THE DRAWINGS

In the drawings wherein:

FIG. 1 is an orthographic view of the assembled work platform of the present invention.

FIG. 2 is a side view of one of the typical adjustable legs or outriggers of the work platform of FIG. 1 with the arm retracted.

FIG. 3 is a side view of the FIG. 2 leg or outriggers with the arm in a fully extended position.

FIG. 4 is an isometric view of the FIG. 3 leg or outrigger with the leg rotated 0 degrees.

FIG. 5 is an isometric view of the FIG. 3 leg or outrigger with the leg rotated to a maximum of 40 degrees (typical both directions).

FIG. 6 is a side view of a sea-land container having one section of the platform assembly contained therein for shipment.

FIG. 7 is an isometric view of the sea-land container of FIG. 6.

FIG. 8 is a side view of a sea-land container having a section of the platform assembly, along with supporting component items, contained therein for shipment.

FIG. 9 is an isometric view of the sea-land container of FIG. 8.

FIG. 10 is a top view of the work platform of FIG. 1 having all the legs or outriggers tucked in to conserve refuel floor space prior to installation in the reactor cavity.

FIG. 11 is a top view of the FIG. 1 platform showing how the legs are extended and rotated to accomplish one typical mounting in a reactor.

FIG. 12 is a top view of the FIG. 1 platform showing how the legs are extended and rotated to accomplish another typical mounting in a differing reactor.

FIG. 13 is a top view of the FIG. 1 platform showing how the legs are extended and rotated to accomplish yet a third typical mounting in a third reactor

### DESCRIPTION OF THE PREFERRED EMBODIMENT

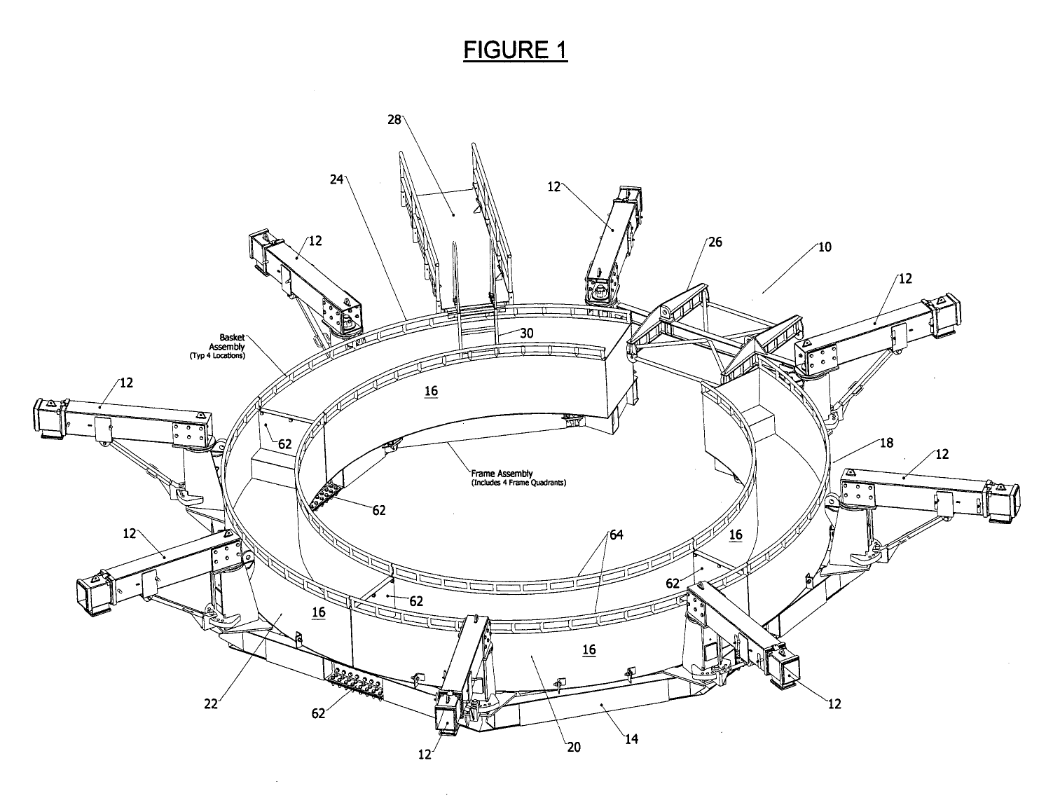

Referring now to the drawings generally and FIG. 1 in particular, a Reactor Cavity Work Platform (RCWP) assembly (10) is shown easily installable inside various BWR (Boiling Water Reactor) cavities to allow inspection/repair of the reactor and other components, but maintain clearance from the reactor core area to allow both the repair/inspection function and fuel assembly movement function to be simultaneously executed. The fuel replacement/movement area includes ancillary facilities such as a fuel storage pool for storing spent fuel assemblies and an equipment storage pool. The area also includes surge tank plugs and service boxes (not shown).

In order to reduce refueling outage durations, utilities that operate Boiling Water Reactors (BWRs) are reviewing all outage tasks/processes to identify areas where critical path duration reductions can be attained. One such task is the performance of the In-Vessel Visual Inspections, which requires approximately 72 hours. Current in-vessel inspection methods result in recurring interferences with fuel off-load and re-load efforts. As a result, the RCWP (10) is designed to facilitate inspections without impeding refueling activities, is capable of adapting to various reactors and refuel floor configurations via adjustable structural support leg assemblies (12) or outriggers. The RCWP is easily transportable over-the-road using four sea-land containers. This is possible since the RCWP is comprised of three main structures (12, 14, 16) which are integral in allowing this structure to be versatile and adjustable to various reactor and refuel floor configurations. These three items are listed below:
1) Structural Support Legs (12) also referred to as Outriggers.
2) Lower Structural Frame (14) also referred to as the Frame.
3) Personnel Work Stations (16) also referred to as the Baskets.

The above mentioned items identified comprise four separate section assemblies (18, 20, 22, 24) and are shipped to the site in four (4) 20′×8′×10′ Sea-Land containers. In addition to the items identified above, a jib crane, a spreader beam assembly (26), an access platform (28), access ladder (30), and necessary rigging are all packaged and shipped in four sea-land containers.

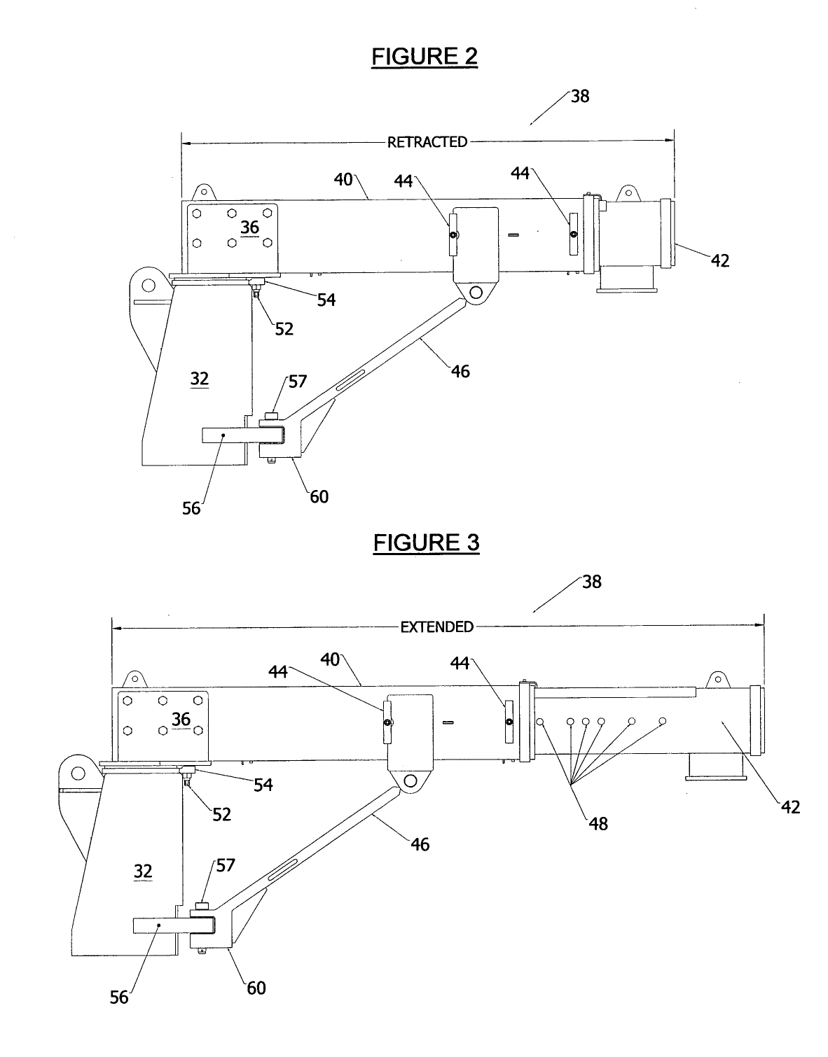

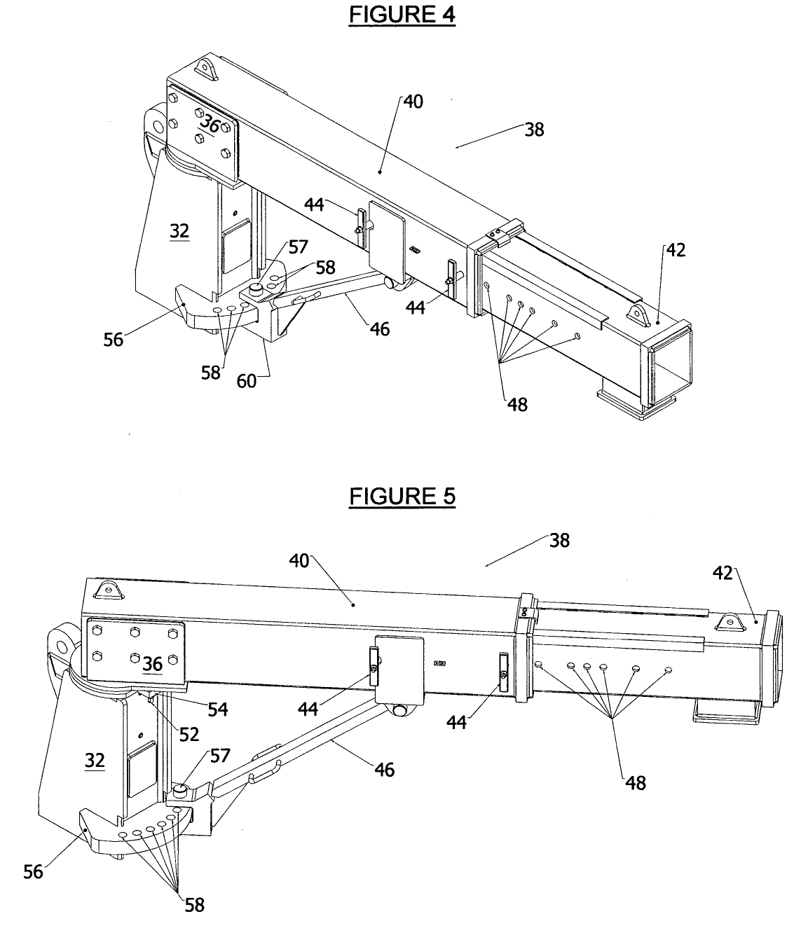

The outrigger assemblies (12) are used to provide the necessary support for the RCWP once it is installed above the applicable reactor vessel (RV). The RCWP utilizes eight (8) of these outrigger assemblies (12), which have been designed to be the most versatile feature on the RCWP. As best seen in FIGS. 2-5, each outrigger assembly (12) consists of a fixed base outrigger upright (32) which is welded to the RCWP frame (14) (see FIG. 1). This upright (32) consists of a stainless steel weldment that provides a method for attachment of a replaceable rotation pin (not shown). This pin provides the necessary attachment location for a U-shaped squash plate assembly (36) which serves as the method for attachment of the outrigger arm assemblies (38). Each outrigger arm assembly (38) consists of an outer arm (40), an inner arm (42), arm locator pins (44), and a strut assembly (46). As such, once the arm assemblies (38) are properly installed, these assemblies can rotate about the above mentioned rotation pin while the inner arm (42) can telescope (lengthen/shorten) as required between the retracted and extended positions into the outer arm (40) as seen in FIGS. 2-5 by moving the pins (44) into various spaced holes (48) found on the inner arm (42). All sliding and rotating joints are separated by sliding plates (not shown) to provide smooth operation during installation and alignment of these assemblies. The outrigger inner arm can be adjusted to telescope as needed and then uses the two (2) arm pins (44) to prevent the two arms (outer and inner) from telescoping/moving. To control the azimuth location of the outrigger arm assembly (38) in relation to the upright assembly (32), a locator pin (52) is inserted into a locator pin block (54) mounted to the outrigger upright (32). This locator pin (52) threads through the block into the underside of the squash plate assembly (36) and locks the azimuthal location of the outrigger arm (38) by locating the pin (52) into the appropriate hole found on the underside of the squash plate assembly (36). Additionally, once the locator pin (52) is installed in the applicable location hole, the lower jaw (60) of the strut assembly (46) is pinned (57) in place in the corresponding hole (58) in the index plate (56), which is welded to the lower region of the outrigger upright (32).

Referring back to FIG. 1, the associated frame used to support the various subassemblies of the RCWP (10) is constructed of fabricated stainless steel structural members. This frame consists of the four sections (18, 20, 22, 24) that when connected together make up the entire RCWP frame. Each of the sections has joints (62) which utilizes a series of splice plates and fasteners to fully connect each section together. All required splice plate fasteners (bolts, washers, nuts, etc.) are considered replacement items. As stated above, the outrigger assemblies (12) are welded to a reinforced base plate at each required location on the frame. In addition to these assemblies, the frame also provides the necessary support and attachment locations for the baskets (16).

The RCWP has four (4) basket assemblies (16) used for work activities, which provides 330-degrees of circumferential access to the reactor with the remaining 30-degrees allowing movement of fuel from the reactor vessel to the fuel storage pool. Each basket assembly (16) is constructed of stainless steel and is equipped with handrails (64). Additionally, each basket assembly is equipped with both electrical service and compressed air supply for in-vessel inspection equipment. All electrical and air systems onboard the RCWP require a connection to the applicable plant service supply on the Refuel Floor.

The access platform (28) is utilized to provide a walkway from the refuel floor to the RCWP. This separate structure is installed after the RCWP has been placed in the cavity. This access platform (28) relies on the refuel floor and the RCWP basket handrails (64) for support.

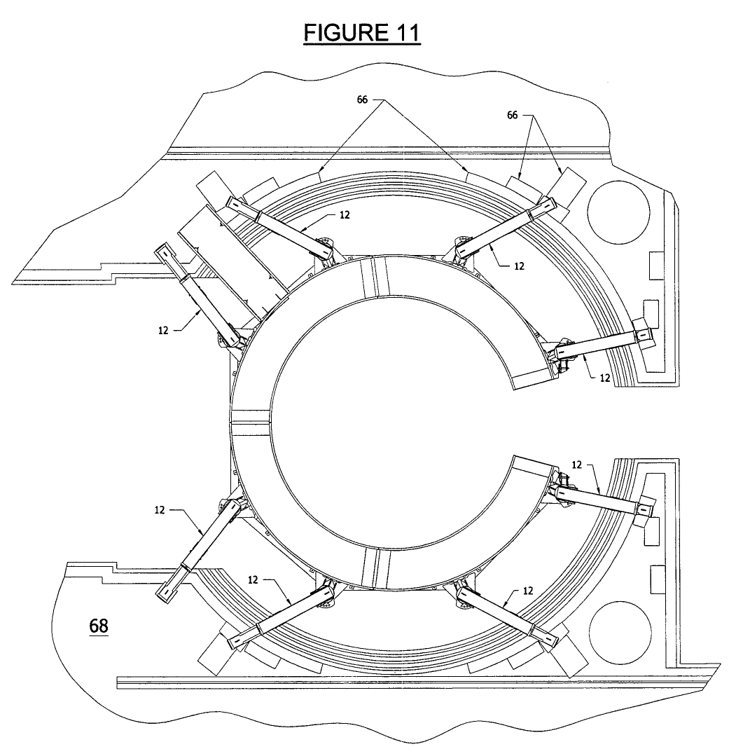

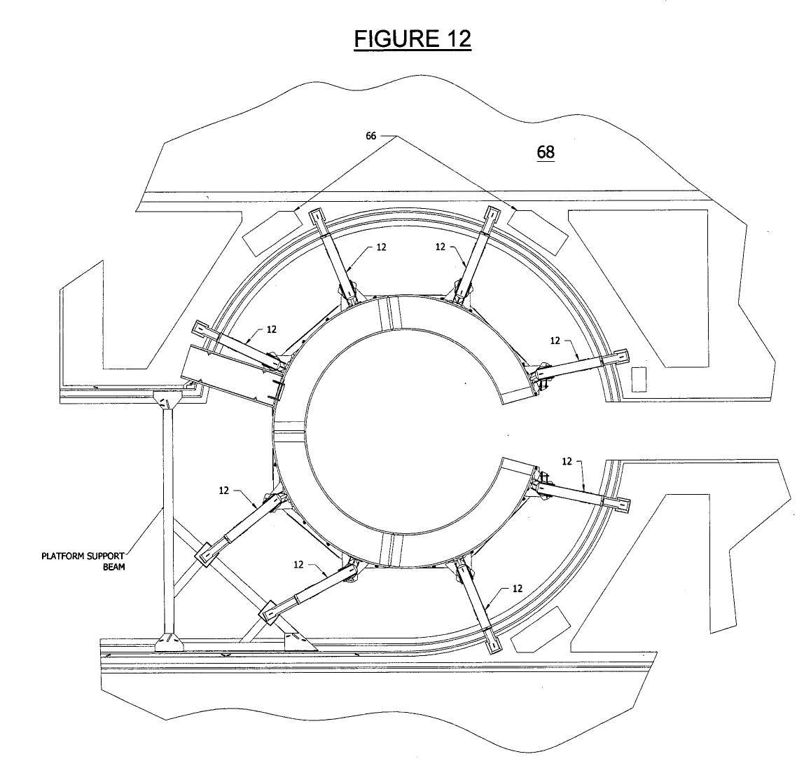

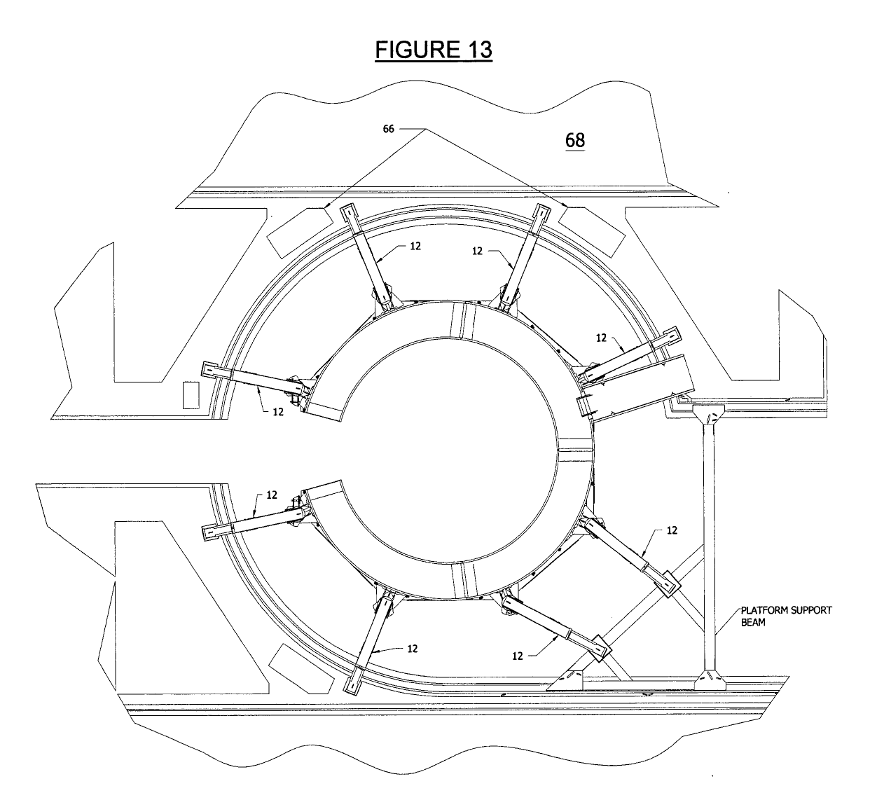

The outrigger assemblies (12) are adjustable such that these structural support members (arm assemblies (38)) can be positioned by telescoping and rotating to miss critical areas in the refuel cavity and/or reactor floor (68) as see in FIGS. 11-13 which shows three different reactor refuel floor layouts. These critical areas are found in different locations for different reactors and normally consist of the following fixed objects which must be avoided during the installation of the RCWP onto the refuel floor: refuel bridge crane rails, service pits (66) which contain electrical and air supply, non-structural portions of the floor, refuel floor cavity curb, electrical distribution panels, and handrail posts.

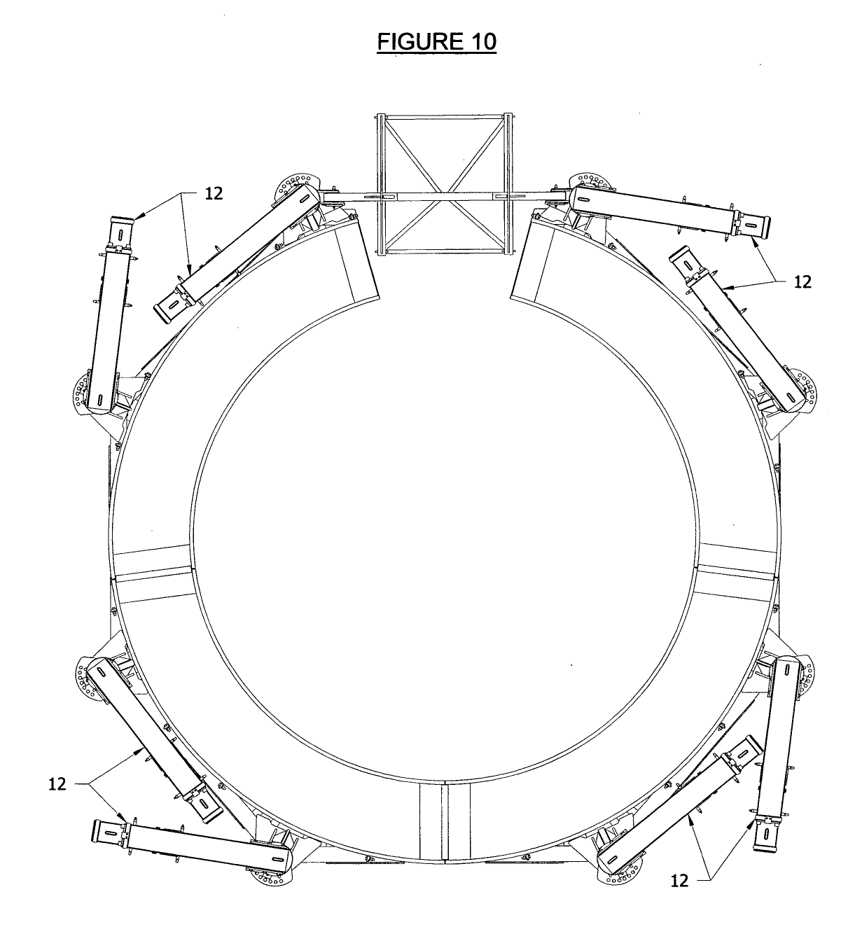

Additionally, depending on the available refuel floor space (68), it may be necessary to assemble the four sections of the RCWP and rotate or tuck the outrigger arm assemblies (38) inward to reduce the amount of floor space taken up prior to installing this structure as is best seen in FIG. 10. As such, if these arm assemblies were rotated inward, these arm assemblies (38) can be rotated as the entire structure was moved toward the refuel cavity prior to being completely installed at which time the arm assemblies (38) would be extended and rotated as necessary to clear critical areas and install the RCWP to the refuel floor (68).

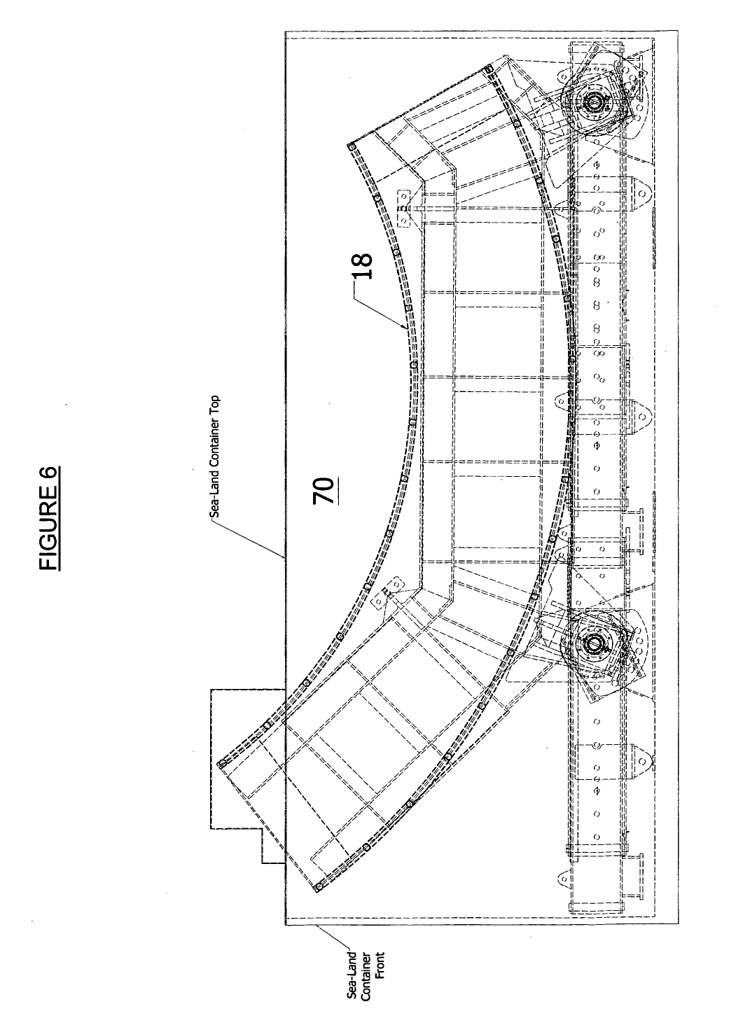

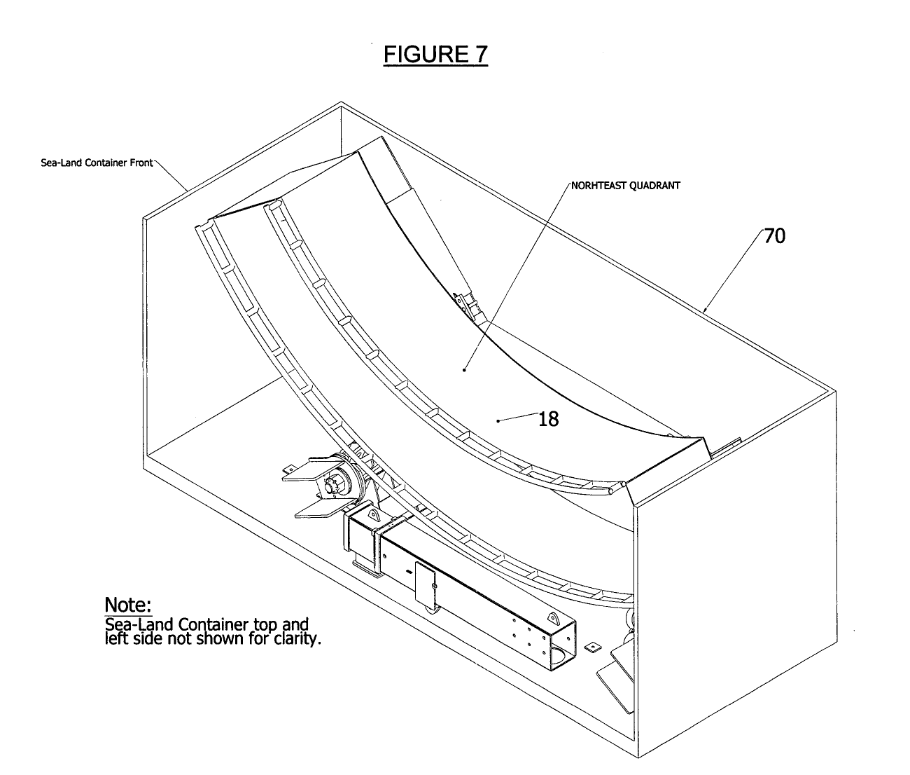

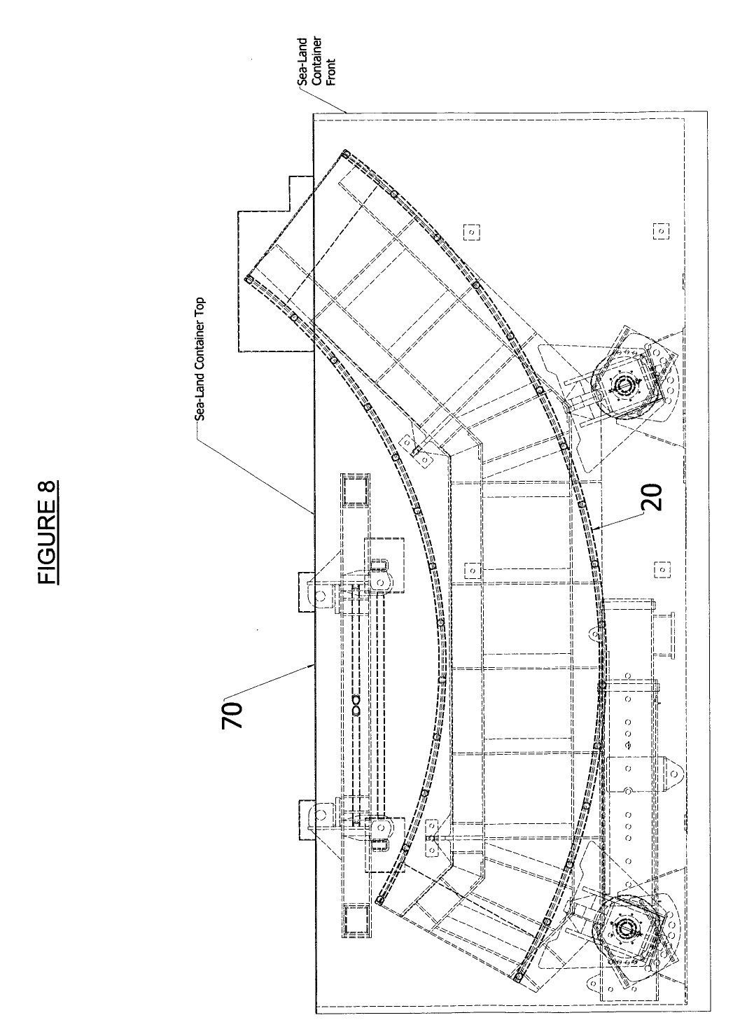

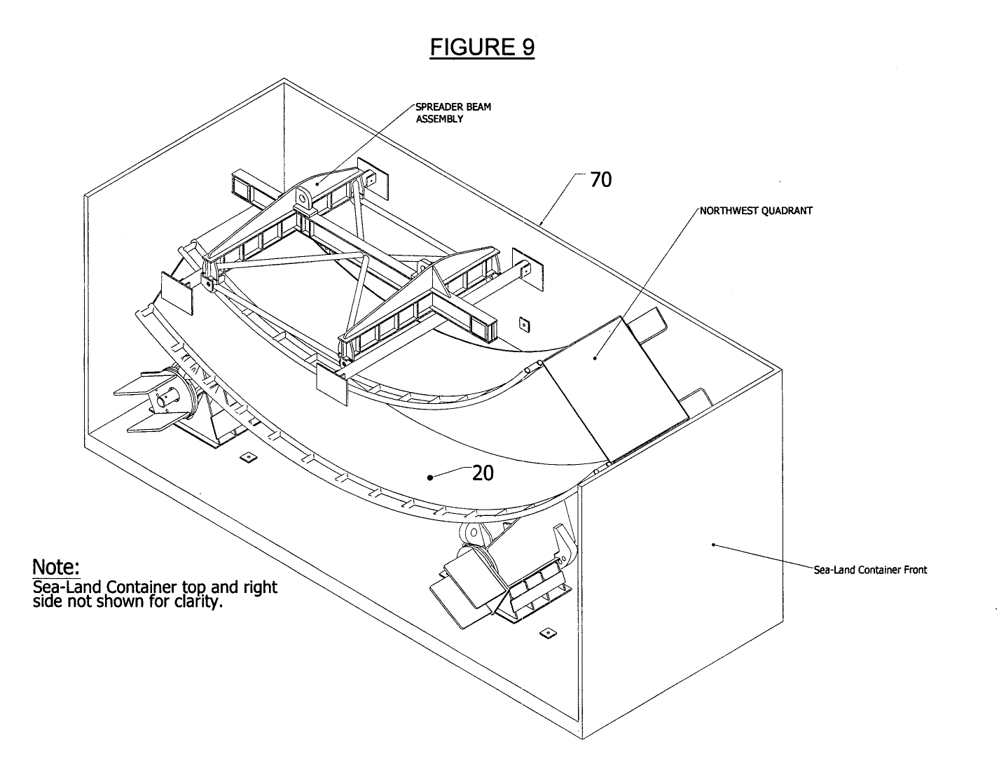

As discussed earlier, the RCWP has been designed such that it can be disassembled, packaged in four sea-land containers (70), and shipped over-the-road to the next BWR utility site. As depicted in FIGS. 6-9, the applicable RCWP quadrants are packaged in corresponding sea-land containers. Only the two right most sections shown in FIG. 1 are depicted in the two containers (70) in both a front and isometric perspective view, but there are a total of four sea-land containers used for shipping the four individual sections. Additionally, the miscellaneous items associated with the RCWP, i.e. outrigger arms, struts, access platform, spreader beam, fasteners, etc. are also packaged in these sea-land containers.

It will be understood that certain details, obvious modifications and applications have been deleted herein for the sake of conciseness and readability but are fully intended to fall within the scope of the following claims.

1. A work platform system for use in a nuclear reactor vessel during refueling operations comprising:
a work platform comprising a plurality of sections easily assembled into a reactor cavity installed and refuel floor supported integral assembly;
a series of movable outrigger assemblies mounted to said work platform for installing the said platform to said refuel floor so as to avoid critical areas of said refuel floor.

2. A work platform system as set forth in claim 1 wherein said movable outrigger assemblies comprise of an arm assembly having an outer and an inner arm with said inner arm being retractable into said outer arm to vary the length of said arm assembly to avoid critical areas of said refuel floor.

3. A work platform system as set forth in claim 1 wherein said movable outrigger assemblies comprise of a rotatable arm assembly rotatable to vary the angle of placement of said arm assembly from said work platform to avoid critical areas of said refuel floor.

4. A work platform system as set forth in claim 2 wherein said inner arm has a series of holes and said outer arm has pins fitting said holes to lock said inner arm into position into said outer arm.

5. A work platform system as set forth in claim 3 wherein arm assembly is connected to a platform by a squash plate assembly and index plate which has a series of holes used by a strut assembly which is retained to one hole of said platform by a pin extending from said strut assembly through said one hole.

6. A work platform system as set forth in claim 1 wherein said series of outrigger assemblies may be tucked in against said work platform to save space for installations having limited refuel floor space.

7. A portable work platform system as set forth in claim 1 wherein said work platform is formed from a plurality of sections to have approximately 330 degrees of annulus with the remaining section being used for refueling movement activities.

8. A work platform system as set forth in claim 1 wherein said work platform is made up from four sections with each section fitting into a sea-land container for easy transportation to another utility site.

9. A work platform system as set forth in claim 1 wherein said plurality of outrigger assemblies comprises eight assemblies.

10. A portable work platform system as set forth in claim 9 wherein said eight outrigger assemblies are both extendable and rotatable to clear critical mounting areas of said refuel floor.

11. A portable work platform system as set forth in claim 10 wherein said critical mounting areas of said refuel floor include service pits.
